(19) United States
(12) Patent Application Publication
(10) Pub. No.: US 2023/0136592 A1
(43) Pub. Date: May 4, 2023

(54) TRANSFORMER AND MANUFACTURING METHOD

(71) Applicant: HITACHI ENERGY SWITZERLAND AG, Baden (CH)

(72) Inventors: Lukasz MICHALSKI, Lodz, Lodzkie (PL); Pawel KLYS, Lodz (PL); Marcel CIESIELSKI, Lodz (PL); Witold SOBCZAK, Pabianice (PL)

(21) Appl. No.: 17/918,779

(22) PCT Filed: Apr. 30, 2021
(86) PCT No.: PCT/EP2021/061444

§ 371 Date: Oct. 13, 2022

(30) Foreign Application Priority Data
May 6, 2020 (EP) 20173266.6

(51) Int. Cl. H01F 27/02; H01F 27/26; H01F 41/02

(52) U.S. Cl. CPC H01F 27/02; H01F 27/266; H01F 41/0206

(57) ABSTRACT

A transformer comprises a tank having tank walls. The tank walls comprise composite panels having a core. The tank has a fluid-tight insert.

### CROSS REFERENCE TO RELATED APPLICATIONS

This application is a 35 U.S.C. § 371 national stage application of PCT International Application No. PCT/EP2020/050867 filed on Sept. 17, 2020, which in turn claims priority to U.S. Provisional Patent Application No. 62/902,635, filed on Sep. 19, 2019, the disclosures and content of which are incorporated by reference herein in their entireties.

### TECHNICAL FIELD

The invention relates to transformers and, more particularly, to oil-insulated transformers.

### BACKGROUND

Oil-insulated transformers are widely used in power generation, transmission, and/or distribution. Oil-insulated transformers have a tank that is intended to retain the insulation oil. Similar tanks may be used in other fluid-insulated transformers.

Conventionally, transformer tanks consist of solid metal walls. Stiffener structures may be arranged on the inner surface of the metal walls. Such a construction typically is associated with a significant weight and/or significant cost in the manufacturing process. The presence of stiffeners structures may allow metal walls of smaller thickness to be used, but causes an undesirable increase in spacing between the transformer active part and the walls.

CN 208 632 440 U discloses a coating structure for a transformer oil tank.

US 2017/0279251 A1 discloses a transformer which includes a fluid-filled tank having side walls. For protection against bombardment and/or fragmentation effects, the side walls are formed in a bullet-resistant manner and are made of a material having a traction strength of greater than 1000 MPa, or a bullet-resistant reinforcement made of such a material is provided.

### SUMMARY

There is a need to provide improved transformer tanks. There is in particular a need to provide transformer tanks and methods of manufacturing the same that have the capability to securely retain an insulating fluid such as insulation oil, while offering an enhanced balance of structural integrity or resistance vs. weight as compared to conventional transformer tank designs. There is in particular a need to provide transformer tanks and methods of manufacturing the same that allow active transformer parts to be positioned more closely to the tank walls.

A transformer and a manufacturing method as recited in the independent claims are provided. The dependent claims define embodiments.

According to embodiments, composite panels are used to form the walls of a transformer tank. A transformer tank according to the invention has walls that include composite panels.

The composite panels may have a sandwich structure comprising first and second skin layers, with a core sandwiched between the first and second skin layers.

The core may be a honeycomb core. The core may have another structure, such as an undulated (wave-like) structure. Such composite panels provide desired mechanical characteristics at a low weight.

According to embodiments, there is provided a transformer tank that includes composite panels. The composite panels may be attached on outer surfaces of a fluid-tight insert, in particular of an oil-tight insert. The composite panels may be attached on the outer surfaces of the fluid-tight insert by means gluing, welding, riveting, or bolting, for example. The composite panels may optionally be attached to each other. Joining inserts that are inserted in overlapping relationship with inner and outer skin layers of adjacent composite panels may be provided.

The composite panels may be pre-fabricated panels that can be affixed as an integral unit, such as by gluing, welding, riveting, or bolting. Thus, the transformer tank can be efficiently manufactured.

In the transformer tank, the structural rigidity may be provided by the composite panels. The fluid-tight insert may be operative to prevent the insulation fluid from contacting the composite panels. The structural rigidity may be provided by the composite panels, which may have a higher bending stiffness than the fluid-tight insert. Thus, the functions of providing the desired structural rigidity and providing fluid-tightness may be separated, allowing composite panels that afford good stiffness vs. weight balance to be used.

A transformer according to an embodiment comprises a tank having tank walls, wherein the tank walls comprise composite panels having a core. The tank may have a fluid-tight insert.

The core may be a honeycomb core, an undulated core, or may have another configuration.

The core may preferably define cells while providing a structure that interconnects skin layers of the composite panel in the interior of the composite panel.

The transformer may be an oil-insulated transformer.

The composite panels may have a stiffness, in particular a bending stiffness, that exceeds a bending stiffness of the fluid-tight insert.

The fluid-tight insert may be oil-tight.

A bottom and plural sides of the fluid-tight insert may be integrally formed or joined to each other by welding.

The fluid-tight insert may have an upper rim.

The upper rim may be integrally formed with the plural sides of the fluid-tight insert.

The upper rim may extend such that it extends over upper ends of the composite panels.

The fluid-tight insert may be made of metal.

The fluid-tight insert may be made of polymer.

An inner surface of the fluid-tight insert may be composed of planar faces.

The inner surface of the fluid-tight insert may consist of planar faces, in particular of five planar faces having a rectangular shape.

Bushing openings may be formed in at least one of the planar faces.

The inner surface of the fluid-tight insert may be free from projections, in particular free from stiffener structures.

The composite panels may abut on an outer surface of the fluid-tight insert.

The composite panels may be affixed to the outer surface of the fluid-tight insert by means of an adhesive.

The tank walls may include a bottom wall and several side walls. The bottom wall and each of the several side walls may respectively comprise at least one composite panel.

The bottom wall may comprise several composite panels.

Each of the several side walls may comprise several composite panels.

The several composite panels may be affixed to each other.

The transformer may comprise bushings.

The composite panels may contain or may be made of non-magnetic materials adjacent the bushings.

The composite panels may include a filler in cells of the core, e.g., the honeycomb core. The filler may comprise a loose material. The filler may provide sound-proof characteristics.

Each of the composite panels may include the filler in cells of the core, e.g., the honeycomb core.

The core, e.g., the honeycomb core may comprise or may be formed of at least one of: aluminum, stainless steel, Nomex®, Kevlar®, polypropylene, polycarbonate, without being limited thereto.

The first and second skin layers may comprise or may be formed of at least one of: aluminum, stainless steel, high pressure laminate, glass/epoxy prepreg, fiberglass, without being limited thereto.

The first and second skin layers may be adhered to the core, e.g., the honeycomb core using an adhesive that is commercial grade toughened epoxy or modified epoxy film adhesive, without being limited thereto.

A transformer according to an embodiment comprises a tank having tank walls, wherein the tank walls comprise composite panels having a core, and wherein the composite panels may be affixed to each other with a joining element inserted between the honeycomb cores of adjacent composite panels.

The core may be a honeycomb core, an undulated core, or may have another configuration.

The core may preferably define cells while providing a structure that interconnects skin layers of the composite panel in the interior of the composite panel.

The joining element may be made of a material that is weldable to a skin layer of the composite panels.

Adjacent composite panels may be attached to each other in an oil-tight fashion.

Adjacent composite panels may be attached to each other by an oil-tight weld seam.

Adjacent composite panels may be attached to each other using bolts or rivets. An oil-tight connection may be attained by using oil-tight joining elements.

The composite panels may include a first composite panel and a second composite panel that are arranged angled relative to each other, in particular at an angle of 90°.

A joining element may extend between the cores, e.g., the honeycomb cores of first and second composite panels that are arranged angled relative to each other to provide a transition therebetween.

The joining element may have first and second joining faces abutting on first and second skin layers of adjacent composite panels.

The joining element may have internal strut members extending between the first and second joining faces of the joining element.

Weld lines between adjacent composite panels and/or weld lines between the composite panels and the joining element may be offset from adhesive layers that join the cores, e.g., the honeycomb cores to the skin layers of the adjacent composite panels.

A method according to an embodiment comprises using composite panels to form walls of a transformer tank.

The composite panels may have a sandwich structure comprising first and second skin layers, with the core, e.g., the honeycomb core sandwiched between the first and second skin layers.

A method of producing a transformer tank according to an embodiment comprises forming a fluid-tight insert and affixing composite panels having a core, in particular a honeycomb core on the fluid-tight insert.

The fluid-tight insert may be formed as an integral component having a bottom and sides that are formed by bending or by vacuum forming.

Forming the fluid-tight insert may comprise joining a bottom and sides of the fluid-tight insert by producing oil-tight weld seams.

Affixing the composite panels may comprise affixing the composite panels on the fluid-tight insert by means of an adhesive.

In the method, the composite panels may have a stiffness, in particular a bending stiffness, that exceeds a bending stiffness of the fluid-tight insert.

In the method, the fluid-tight insert may be oil-tight.

Forming the fluid-tight insert may comprise forming an upper rim of the fluid-tight insert.

Forming the upper rim may comprise integrally forming the upper rim with the plural sides of the fluid-tight insert.

The upper rim may be formed to extend such that it extends over upper ends of the composite panels.

In the method, the fluid-tight insert may be made of metal.

In the method, the fluid-tight insert may be made of polymer.

Forming the fluid-tight insert may comprise forming the fluid-tight insert such that an inner surface of the fluid-tight insert are composed of planar faces.

Forming the fluid-tight insert may comprise forming the fluid-tight insert such that the inner surface of the fluid-tight insert consist of planar faces, in particular of five planar faces having a rectangular shape.

Forming the fluid-tight insert may comprise forming bushing openings in at least one of the planar faces.

Forming the fluid-tight insert may comprise forming the fluid-tight insert such that the inner surface of the fluid-tight insert is free from projections, in particular free from stiffener structures.

Affixing the composite panels may comprise affixing the composite panels such that the composite panels abut on an outer surface of the fluid-tight insert.

Affixing the composite panels may comprise forming both a bottom wall and each of several side walls of the tank using composite panels.

The bottom wall may be formed to comprise several composite panels.

Each of the several side walls may be formed to comprise several composite panels.

Affixing the composite panels may comprise affixing several composite panels to each other.

In the method, the composite panels may be formed to contain or be made of non-magnetic materials adjacent bushings of a transformer.

In the method, the composite panels may include a filler in cells of the core, e.g., the honeycomb core. The filler may comprise a loose material. The filler may provide sound-proof characteristics.

In the method, each of the composite panels may include the filler in cells of the core, e.g., the honeycomb core.

In the method, the composite panels may have a sandwich structure comprising first and second skin layers, with the core, e.g., the honeycomb core sandwiched between the first and second skin layers.

In the method, the core, e.g., the honeycomb core may comprise or may be formed of at least one of: aluminum, stainless steel, Nomex®, Kevlar®, polypropylene, polycarbonate, without being limited thereto.

In the method, the first and second skin layers may comprise or may be formed of at least one of: aluminum, stainless steel, high pressure laminate, glass/epoxy prepreg, fiberglass, without being limited thereto.

In the method, the first and second skin layers may be adhered to the core, e.g., the honeycomb core using an adhesive that is commercial grade toughened epoxy or modified epoxy film adhesive, without being limited thereto.

The method may further comprise installing an active transformer part in an interior of the tank.

The method may further comprise filling the tank with an insulation fluid, in particular with insulation oil.

A method of forming a transformer according to an embodiment comprises forming a tank having tank walls, comprising affixing composite panels having a core to each other with a joining element inserted between the cores of adjacent composite panels.

The core may be a honeycomb core, an undulated core, or may have another configuration.

The core may preferably define cells while providing a structure that interconnects skin layers of the composite panel in the interior of the composite panel.

In the method, the joining element may be made of a material that is weldable to a skin layer of the composite panels.

Affixing adjacent composite panels to each other may comprise affixing the adjacent composite panels to each other in an oil-tight fashion.

Affixing adjacent composite panels to each other may comprise affixing the adjacent composite panels by an oil-tight weld seam.

Affixing adjacent composite panels to each other may comprise affixing the adjacent composite panels using bolts or rivets.

In the method, the composite panels may include a first composite panel and a second composite panel that are arranged angled relative to each other, in particular at an angle of 90°.

In the method, the joining element may extend between the cores, e.g., the honeycomb cores of first and second composite panels that are arranged angled relative to each other to provide a transition therebetween.

In the method, the joining element may have first and second joining faces abutting on first and second skin layers of adjacent composite panels.

In the method, the joining element may have internal strut members extending between the first and second joining faces of the joining element.

In the method, adjacent composite panels may be welded to each other along weld lines that are offset from adhesive layers that join the cores, e.g., the honeycomb cores to the skin layers of the adjacent composite panels. Alternatively, or additionally, adjacent composite panels may be welded to the insert member along weld lines that are offset from adhesive layers that join the cores, e.g., the honeycomb cores to the skin layers of the adjacent composite panels.

In any one of the embodiments, the transformer may be a power transformer for an electric power transmission and/or distribution system.

In any one of the embodiments, the transformer may be a distribution transformer.

In any one of the embodiments, the transformer may be a traction transformer.

In any one of the embodiments, the transformer may be a transformer having a rating of at least 6 kVA, at least 15 kVA, or at least 25 kVA.

In any one of the embodiments, the transformer may have a rating of at least 200 kVA, at least 300 kVA, or at least 400 kVA.

In any one of the embodiments, the transformer may include an insulation fluid.

The insulation fluid may be at least one of the following: mineral oil, dimethyl silicone, esters and synthetic hydrocarbons.

In any one of the embodiments, the transformer may be a single phase transformer.

In any one of the embodiments, the transformer may have plural phases.

In any one of the embodiments, the sandwich panel core may have cells with a hexagonal shape extending along a cell longitudinal axis. When assembled, the cell longitudinal axis of the hexagonal cells may extend in a direction orthogonal to the side or bottom of the transformer tank on which the composite panel is used. In other words, the cell longitudinal axis may extend parallel to the normal line of the side or bottom that includes the respective composite panel.

An electric power transmission and/or distribution system according to an embodiment comprises the transformer according to any one of the embodiments disclosed herein.

According to an embodiment, there is provided a use of one or several composite panels comprising a core for forming walls of a transformer tank.

The core may be a honeycomb core, an undulated core, or may have another configuration.

The core may preferably define cells while providing a structure that interconnects skin layers of the composite panel in the interior of the composite panel.

The use may comprise forming the transformer tank according to any one of the embodiments disclosed herein.

Various effects are attained by the transformers and methods according. The transformer tank construction utilizes a modular approach to provide a simple way of creating a robust tank structure to accommodate various sizes of transformer active parts. Such a tank structure that utilizes composite panels for providing structural support and dimensional integrity affords the required pressure and puncture resistance. Paint and aging resistance of the panels is attainable. A full enclosure can be constructed from the composite panels by properly selecting the position, size and edge finishing of the panels. The fluid-tight insert and/or oil-tight weld seams can prevent the adhesive in the interior of the composite panels and/or the adhesive between the composite panels and the fluid-tight insert from contacting the insulation oil. Thus, the composite panels are separated from the interior volume of the tank, such that the adhesive is not degraded by the insulation fluid.

The transformer tank can be assembled in a less complex manner than conventional transformer tanks. The composite panels allow a weight reduction to be attained by offering a high stiffness to weight ratio. The composite panels also allow noise insulation to be attained. To enhance noise insulation, cores filled with a sound attenuating medium may be used.

The transformer tank construction does not require inner ribs to be used as stiffeners and, hence, allows the tank walls to be placed closer to the active part of the transformer than conventionally. This reduces the amount of insulation fluid, e.g., the amount of insulation oil.

By using a set of pre-fabricated composite panels of various lateral dimensions and/or thickness, various transformer tank dimensions can be readily attained by combining composite panels from the pre-fabricated set. This greatly facilitates the manufacturing process and affords adaptability to various transformer tank dimensions.

### BRIEF DESCRIPTION OF THE DRAWINGS

The subject-matter will be explained in more detail with reference to preferred exemplary embodiments which are illustrated in the attached drawings, in which:

FIG. 1 is a schematic view of a transformer tank in accordance with an embodiment.

FIG. 2 is a schematic view of a fluid-tight insert of the transformer tank of FIG. 1.

FIG. 3 is a schematic perspective view of a composite panel of the transformer tank of FIG. 1.

FIG. 4 is a schematic side view of a transformer according to an embodiment.

FIGS. 5A and 5B are schematic views illustrating a technique of forming a fluid-tight insert in a method of manufacturing a transformer tank according to an embodiment.

FIGS. 6A through 6F are schematic cross-sectional views illustrating exemplary edges of composite panels.

FIG. 7 is a schematic view of adjacent composite panels of a transformer tank in accordance with an embodiment.

FIG. 8 is a schematic view of adjacent composite panels of a transformer tank in accordance with an embodiment.

FIG. 9 is a schematic view of adjacent composite panels of a transformer tank in accordance with an embodiment.

FIG. 10 is a schematic view of adjacent composite panels of a transformer tank in accordance with an embodiment.

FIG. 11 is a schematic view of adjacent composite panels of a transformer tank in accordance with an embodiment.

### DETAILED DESCRIPTION OF EMBODIMENTS

Exemplary embodiments of the subject matter will be described with reference to the drawings in which identical or similar reference signs designate identical or similar elements. While some embodiments will be described in the context of a distribution transformer, the embodiments are not limited thereto. The features of embodiments may be combined with each other, unless specifically noted otherwise.

According to embodiments, composite panels having a core and first and second skin layer sandwiching the core therebetween are used for forming a transformer tank. The core may be a honeycomb core, without being limited thereto.

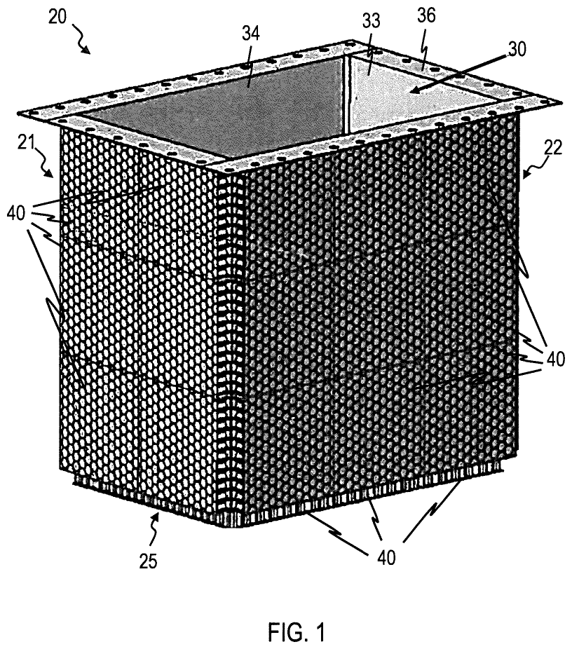

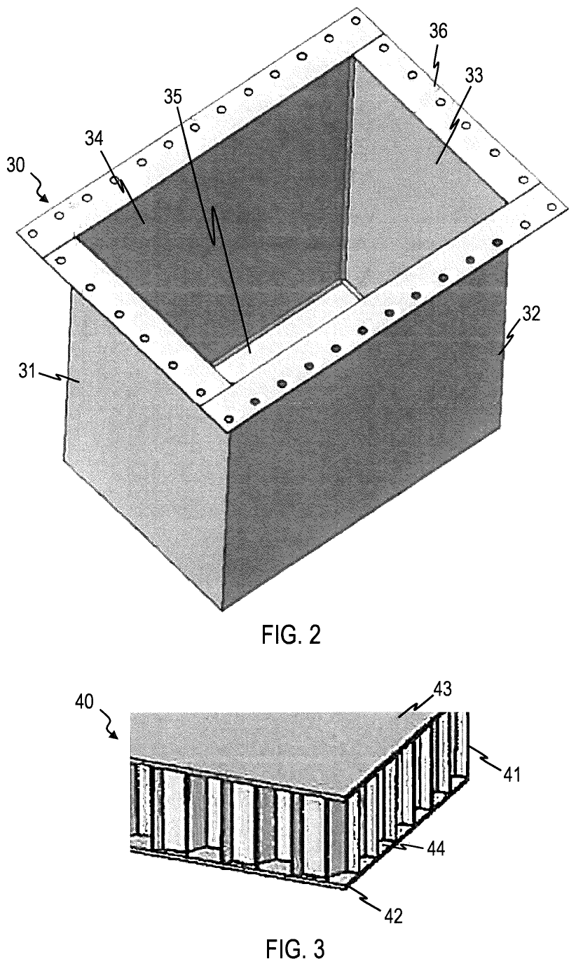

FIG. 1 is a perspective view of a tank 10 of a transformer according to an embodiment, which has a bottom 25 and several sides 21, 22 that each comprise plural composite panels 40, with a fluid-tight insert 30 (such as an oil-tight insert) arranged on inner sides of the composite panels 40 of the wall construction. FIG. 2 shows a schematic perspective view of the fluid-tight insert 30, and FIG. 3 shows a schematic partial view of a composite panel 40 of the tank 10.

The tank 10 has a construction that uses the insert 30 as a fluid-tight, e.g., oil-tight container. It will be appreciated that the term “fluid-tight” as used herein in particular is intended to mean tight against passage of an insulation fluid of the transformer at all locations but those at which openings are provided in the insert 30 to purposively allow the passage of the insulation fluid. The insulation fluid may be insulation oil, without being limited thereto.

The fluid-tight insert 30 may provide a box-like structure having a bottom 35 and plural sides 31-34. The fluid-tight insert 30 has an upper rim 36 that may be integrally formed with the plural sides 31-34. For illustration, the upper rim 36 may be formed by bending portions of the sides 31-34. The bottom 35 and the sides 31-34 may each be rectangular. The fluid-tight insert serves to provide the desired fluid-tight characteristics of the tank 10, while preventing insulation fluid (e.g., insulation oil) from contacting the composite panels 40.

The composite panels 40 are arranged on and along the outer surface of both the bottom 35 and the sides 31-34 of the fluid-tight insert 30. As best seen in FIG. 1, a first set of composite panels 40 may be arranged on an outer surface of a first side 31 of the fluid-tight insert 30 to provide the desired structural integrity or resistance, in particular stiffness and puncture resistance, along a first side wall 21 of the transformer tank 10. A second set of composite panels 40 may be arranged on an outer surface of a second side 32 of the fluid-tight insert 30 to provide the desired structural integrity or resistance, in particular stiffness and puncture resistance, along a second side wall 22 of the transformer tank 10. Third and second sets of composite panels (not shown in FIG. 1) may be arranged on outer surfaces of a third side 33 and of a fourth side 34 of the fluid-tight insert 30 to provide the desired structural integrity or resistance, in particular stiffness and puncture resistance, along third and fourth side walls of the transformer tank 10. A fifth set of composite panels 40 may be arranged on an outer surface of the bottom 35 of the fluid-tight insert 30 to provide the desired structural integrity or resistance, in particular stiffness and puncture resistance, along a bottom wall 25 of the transformer tank 10.

The transformer tank 10 provides the necessary stiffness and fluid-tightness, with the desired stiffness being provided by the composite panels 40 and the desired fluid-tightness being provided by the fluid-tight insert 30. The composite panels 40 may have a stiffness that exceeds a stiffness of the walls of the fluid-tight insert 30. For illustration, the composite panels 40 attached to each other along the first side 31 of the fluid-tight insert 30 may have a bending stiffness that exceeds a bending stiffness of the first side 31 of the fluid-tight insert 30. This may similarly apply to the other side walls and the bottom wall 25.

As illustrated in FIG. 2, the inner surface of the fluid-tight insert (which provides the inner surface of the transformer tank 10) may be composed of five planar surfaces that do not have any inward projections provided thereon. Even when used in the assembled transformer, no stiffener elements need to be provided on the inner surfaces of the transformer tank 10 for providing enhanced integrity or resistance. The assembly process is simplified by eliminating the need for internal ribs that are welded to the transformer tank walls in a conventional construction. By eliminating stiffeners from the interior of the tank 10, and obtaining smooth wall surfaces, a closer distance to the active part can be achieved. This allows to amount of transformer oil to be reduced, because the active part can be positioned more closely to the tank walls.

As best seen in FIG. 1, all side walls 21, 22 and the bottom wall 25 of the transformer tank 20 may have a modular construction in which plural composite panels 40 are combined to form a side wall 21, 25 or the bottom wall 25. The composite panels 40 forming the various side walls 21, 25 and the bottom wall 25 can be attached to each other, as will be explained in more detail below. The composite panels 40 forming the various side walls 21, 25 and the bottom wall 25 can be affixed to the fluid-tight insert by means of an adhesive, e.g., by gluing. The composite panels 40 may be affixed to the fluid-tight insert using other techniques, such as by welding, riveting, or bolting.

Transformer tanks having a wide variety of dimensions may be constructed from pre-fabricated composite panels 40 having one or several sets of lateral dimensions and/or thickness dimensions. This allows transformer tanks to be constructed for fluid-insulated transformers of various ratings.

The sides 31-34 and bottom 35 of the fluid-tight insert 30 have a thickness that is less than a thickness of each of the composite panels 40. This allows the fluid-tight insert 30 to be formed as a light-weight component that provides the desired fluid-tight characteristics, while the dimensional rigidity and puncture resistance desired for the transformer tank can be provided by the composite panels 40 that are combined in the side walls 21, 22 and the bottom wall 25 of the transformer tank 10.

The fluid-tight insert 30 may be composed of plural parts that are joined to each other by oil-tight weld seams. The top rim 36, which can accommodate a tank cover, can be formed by bending upper ends of the elements from which the sides 31-34 are formed. The shape of the side 31-34 and bottom 35 must allow connection of the composite panels 40 to the outer surface of the fluid-tight insert 30. The components that form the fluid-tight insert 30 can be joined by torch welding or resistance welding.

To limit number of weld seams, the fluid-tight insert 30 can be built from a smaller number of components using forming techniques such as bending or vacuum forming, as will be explained in more detail with reference to FIGS. 5A and 5B. Vacuum forming may be used to obtain the fluid-tight insert 30 made from a thermoplastic material and utilize it as completely sealed fluid-tight insert 30 that can be manufactured at low costs.

The composite panels 40 are subsequently positioned on the fluid-tight insert, creating a structure that provides rigidity and resistance even when the interior of the tank is filled. The composite panels 40 can be glued to the fluid-tight insert with two component epoxy-based glue (e.g., Loctite EA 9466). The composite panels 40 can be attached to the fluid-tight insert by riveting, bolting, or welding, without being limited thereto.

It will be appreciated that the transformer tank 10 offers various technical effects.

The transformer tank 10 may be adapted to provide resistance to an internal pressure in the tank. The composite panels 40 may be adapted such and may be attached to each other and the fluid-tight insert 30 so as to withstand a static pressure difference of at least 50 kPa between the inner and outer sides of the tank 10.

The transformer tank 10 may offer good puncture resistance. Due to the thickness of the composite panels 40, a puncture would typically affect only the outer skin layer (i.e., the skin layer that faces away from the fluid-tight insert 30). Such a puncture can be detected by visual inspection and can be repaired. For illustration, a puncture can be repaired by filling a puncture opening with a resin or other material.

The transformer tank 10 may offer good corrosion resistance. For illustration, a coating (such as a corrosion-resistant paint) may be applied to part or the entire transformer tank. For illustration, a corrosion-resistant coating may be applied to the inner surfaces of the fluid-tight insert 30.

The transformer tank 10 may offer good aging resistance. For illustration, the transformer tank may have a lifetime of at least thirty years, which is representative of a typical lifecycle of a power transformer.

The transformer tank 10 may offer good chemical resistance. For illustration, the fluid-tight insert 30 may prevent the composite panels 40 from coming into contact with insulation oil, thereby mitigating or eliminating any adverse effects that the insulation fluid can potentially have on the composite panels 40 if it were to contact the composite panels 40.

The transformer tank 10 may offer good resistance to non-rapid temperature changes. In operation, such temperature changes may be from, e.g., −40° C. to 105° C., or in some cases even up to 140° C.

It will be appreciated that various additional effects are provided by the transformer tank 10 that are not readily attainable with conventional transformer constructions.

For illustration, the transformer tank 10 can be easily assembled. The composite panels 40 may be pre-formed elements that can be attached to the fluid-tight insert 30 using adhesive or other efficient joining techniques.

The composite panels 40 offer sound attenuation, in addition to providing structural rigidity. Sound attenuation may be further improved by placing a sound attenuating material into cavities of the honeycomb core.

The transformer tank 10 lends itself to being easily repaired and patched. For illustration, damage, such as puncture, would typically occur locally at the outer skin layer of a composite panel. Such a damage can be readily repaired from outside of the transformer.

The transformer tank 10 has a low weight as compared to a tank having solid walls consisting entirely of metal and offering the same stiffness. The composite panels 40 provide high stiffness in relation to their low weight, when compared to a solid wall that consists entirely of metal.

The transformer tank 10 allows the costs of the transformer to be reduced. For illustration, no reinforcing stiffeners need to be joined to the inner surface of the fluid-tight insert. This allows the active part of the transformer to be positioned more closely to the transformer tank 10, allowing the required volume of insulation fluid to be reduced.

FIG. 3 is a perspective view of a composite panel 40. The composite panel 40 has a first skin layer 42 attached to the honeycomb core 41 by a first adhesive layer 44. The composite panel 40 has a second skin layer 43 attached to the honeycomb core 41 by a second adhesive layer (not shown in FIG. 3).

Various materials can be used for skin layers 42, 43 and/or of the honeycomb cores 41 of the composite panel 40. For illustration, the honeycomb core 41 may comprise or may be formed of at least one of: aluminum, stainless steel, Nomex®, Kevlar®, polypropylene, polycarbonate, without being limited thereto. The skin layers 42, 43 may comprise or may be formed of at least one of: aluminum, stainless steel, high pressure laminate, glass/epoxy prepreg, fiberglass, without being limited thereto. The skin layers 42, 43 may be adhered to the honeycomb core 41 using an adhesive that is commercial grade toughened epoxy or modified epoxy film adhesive.

The characteristics of the composite panels 40 may be customized by appropriately dimensioning the skin layers (e.g., skin layer thickness) and/or the honeycomb core (e.g., the wall thickness, the cross-sectional area of the honeycomb cells, and/or the length of the honeycomb cells) and/or by appropriate selection of materials.

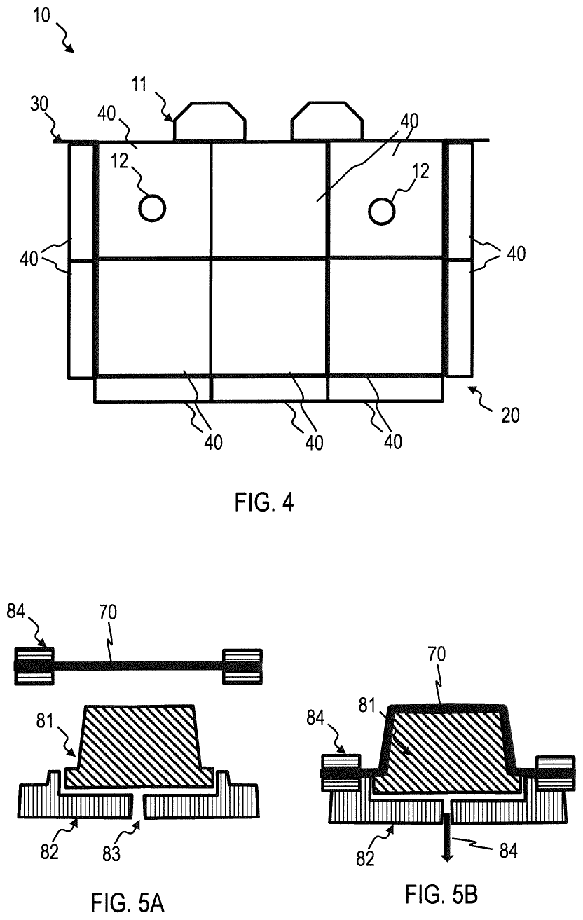

The composite panels 40 may have characteristics that provide desired additional benefits for when used in a transformer tank. A sound attenuating material may be filled into at least some of the cavities of the honeycomb core 41. Alternatively, or additionally, the composite panels 40 may be include materials to attain desired electromagnetic characteristics of the transformer tank walls, as will be explained in more detail with reference to FIG. 4.

FIG. 4 is a schematic side view of a transformer 10 according to an embodiment. The transformer 10 includes a transformer tank 20 having walls formed with a plurality of composite panels 40 and a fluid-tight insert 30 positioned on an inner surface of the shell of composite panels 40.

The transformer 10 includes an active part 11 that is positioned to extend into an inner volume of the transformer tank 20. The transformer 10 includes an insulation fluid, in particular an insulation oil, within the interior volume of the transformer tank 20.

The transformer 10 has bushings 12. The bushings 12 are arranged to extend through the fluid-tight insert 30 and one or several of the composite panels 40. The bushings 12 may be sealed to the fluid-tight insert 30 in a fluid-tight manner.

The composite panel(s) 40 through which the bushing(s) 12 extend may include or may consist of non-magnetic materials, at least in proximity of the bushing(s) 12 or throughout the respective panel(s) 40. Transformer characteristics may be improved thereby.

The composite panels 40 may have various edge configurations. A composite panel may have a first edge configuration along a first edge at which it is not joined to an adjacent panel (as is the case, e.g., for the top edge adjacent the rim 36), and a second edge configuration along a second edge at which is it joined to an adjacent panel, with the second edge configuration being different from the first edge configuration.

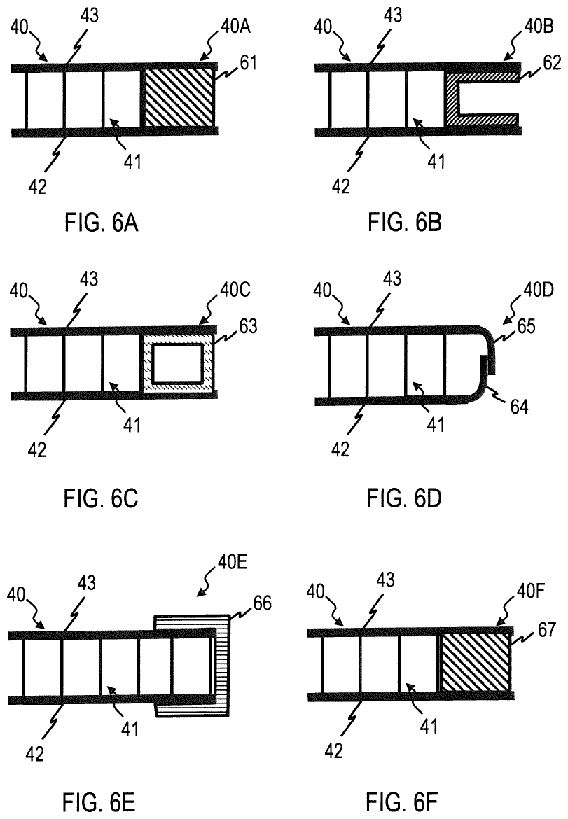

Exemplary edge configurations that may be used in at least some of the composite panels 40 will be explained in more detail with reference to FIG. 6, which shows exemplary edge configurations in cross-sectional views. Generally, the first and second skin layers 42, 43 of the composite panels 40 are dimensioned to extend beyond the honeycomb core 41.

FIGS. 5A and 5B illustrate a technique that may be used to form the fluid-tight insert 30. The fluid-tight insert 30 may be formed as an integral unit. The fluid-tight insert 30 may be formed from a thermoplastic material, e.g., from a thermoplastic polymer, using techniques such as vacuum drawing.

A die 81, 82 is provided that has suction channels 83 formed therein. A sheet of a thermoplastic material 70 is held by clamps 84. The sheet of thermoplastic material 70 is heated and is urged against the die 81, 82 by displacing the clamps 84. A gas flow 84 may be drawn through the suction channels 83 to cause the thermoplastic material 70 to snugly abut on the die 81, thereby shaping the fluid-tight insert 30 without requiring separate sheet of material to be welded together. The top rim 36 of the fluid-right insert 30 may be formed in the same process.

FIGS. 6A-6F show exemplary edge configurations of composite panels. It will be appreciated that these edge configurations are merely exemplary, and that a variety of other edge configurations may be used.

FIG. 6A shows a composite panel 40 having an edge configuration 40A. A solid member 61 is interposed between the first and second skin layers 42, 43 adjacent the honeycomb core 41, thereby providing a solid edge of the composite panel.

FIG. 6B shows a composite panel 40 having an edge configuration 40B. A U-shaped member 62 is interposed between the first and second skin layers 42, 43 adjacent the honeycomb core 41, with the legs of the U-shaped member 62 extending along and being attached to the skin layers 42, 43.

FIG. 6C shows a composite panel 40 having an edge configuration 40C. A hollow, in particular tubular member 63 is interposed between the first and second skin layers 42, 43 adjacent the honeycomb core 41, thereby providing a hollow edge of the composite panel.

FIG. 6D shows a composite panel 40 having an edge configuration 40D. The first and second skin layers are formed adjacent the honeycomb core 41 to provide a formed edge of the composite panel.

The edge configurations of FIGS. 6A, 6B, 6C, and 6D may provide co-fabricated edge close-outs of the composite panels.

FIG. 6E shows a composite panel 40 having an edge configuration 40E. A U-shaped member 66 is positioned in overlapping relationship with the outer surfaces of the first and second skin layers 42, 43, with the legs of the U-shaped member 66 extending along and being attached to the outer surfaces of the skin layers 42, 43. The edge configuration 40E can be formed as a post-fabricated edge close-out.

FIG. 6F shows a composite panel 40 having an edge configuration 40F. A solid member 67 is interposed between the first and second skin layers 42, 43 adjacent the honeycomb core 41 after the first and second skin layers 42, 43 have been attached to the honeycomb core 41, thereby providing a solid edge of the composite panel that is a post-fabricated edge close-out.

The transformer tank 10 that includes a fluid-tight insert 30 does not require the composite panels 40 to be attached to each other in a fluid-tight manner, in particular in an oil-tight manner Sealing is provided via the thin-walled fluid-tight insert 30.

The transformer tank 10 provides a lightweight structure that can withstand considerable pressure. The transformer tank 10 offers good stability and resistance, e.g., to puncturing. Additional benefits can be seen in heat-transfer characteristic and noise attenuation characteristics offered by composite panels 40. For illustration, the honeycomb core 40 can be filled with a loose filler material, such as sand.

The transformer tank 10 provides a modular design which can be easily scaled between small and large size tanks. Tanks for transformers of a wide range of different ratings can be manufactured by combining composite panels selected from a set of various lateral and, optionally, thickness dimensions as well as composite panel materials. The composite panels 40 may be selected according to the transformer rating and may be pre-manufactured for subsequent affixation to the transformer core frame. This allows few sizes of ready-made composite panels to be stocked and used in modular fashion. The types and numbers of composite panels 40 to be used may be selected in accordance with the transformer specifications, e.g., in dependence on the transformer rating.

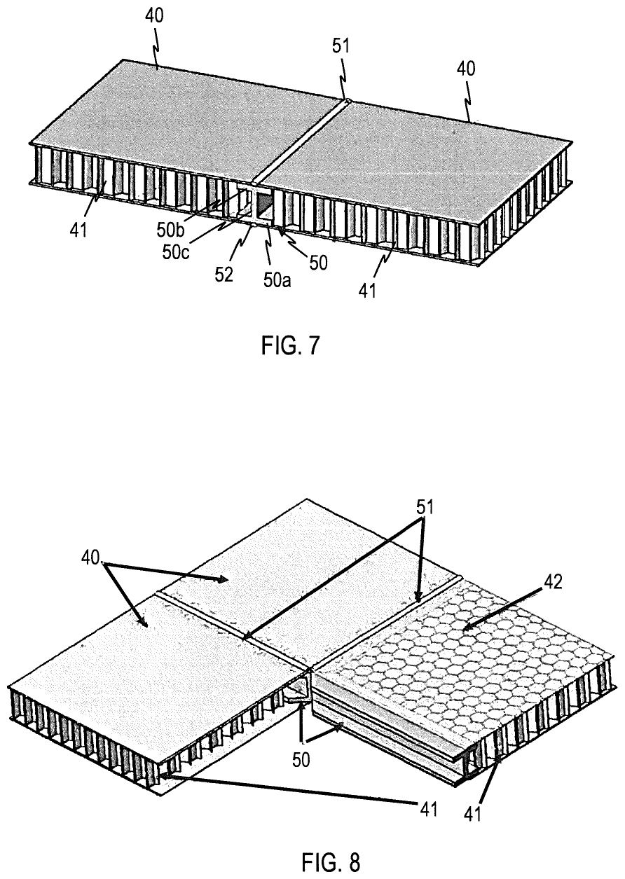

Techniques of joining adjacent composite panels 40 will be described with reference to FIGS. 7 to 11. While the techniques may be used to affix the composite panels 40 to each other when the transformer tank 10 includes a fluid-tight insert 30, the techniques may also be used when no box-like fluid-tight insert 30 is provided. In the latter case, oil-tight weld seams may be used to mitigate the risk of ingress of insulation fluid into the composite panels 40. While the composite panels 40 may be welded to each other, bolting or riveting may be used to attach adjacent composite panels 40.

Generally, a joining element 50, 60 may be used in between two adjacent composite panels 40. The joining element 50, 60 may be inserted in between the honeycomb cores 41 of the adjacent composite panels 40. The joining element 50, 60 may be adapted to allow welding of skin layers in proximity to the joining element 50, 60, while reducing heat transfer from the welding process into the areas at which the honeycomb core 41 is adhered to the skin layers of the composite panel 40. This allows glue degradation to be reduced and mitigates the risk of causing damage to the honeycomb core 41 of the composite panel 40.

Weld seams 51, 52 between adjacent composite panels 40 may be produced in this manner The weld seams 51, 52 may be oil-tight. While the joining technique is described in the context of transformer tanks, it can also be used for joining composite panels in various other fields.

While weld seams 51, 52 are shown, bolting or riveting may be used to attach adjacent composite panels 40. The connection may be made oil-tight by using an oil-tight joining element.

FIG. 7 shows composite panels 40 that extend in a co-planar fashion. A joining element 50 may include two abutment portions 50a, 50b that that extend parallel to and in abutment with the inner surfaces of the skin layers of the composite panels 40 that are to be joined. The joining element 50 has at least one strut 50c extending between the two abutment portions 50a, 50b. The joining element 50 may have a double-T-configuration.

The joining element 50 may have a length that is equal to the length of the composite panels 40 along the edge along the composite panels 40 are to be joined.

Weld seams 51, 52 are formed between the first skin layers and the second skin layers of the adjacent composite panels 40. The weld seams 51, 52 are formed at a location overlapping with the abutment portions 50a, 50b of the joining element 50, and offset (in a direction parallel to the plane in which the composite panels 40 extend) from the honeycomb cores 41.

While two composite panels 40 are shown in FIG. 7, the joining techniques may be applied to more than two composite panels 40. The more than two composite panels 40 may be arranged in a two-dimensional array, as illustrated in FIG. 8. The two-dimensional array of composite panels includes composite panels 40 and several joining elements 50 inserted between honeycomb cores of adjacent composite panels, such that the skin layers 42, 43 of the adjacent composite panels overlap the joining elements 50. The weld seams 51 may respectively be offset from the areas at which the honeycomb core 41 is adhered to the skin layers of the composite panel 40. This allows glue degradation to be reduced and mitigates the risk of causing damage to the honeycomb core 41 of the composite panel 40.

While weld seams 51, 52 are shown, bolting or riveting may be used to attach adjacent composite panels 40. The connection may be made oil-tight by using an oil-tight joining element.

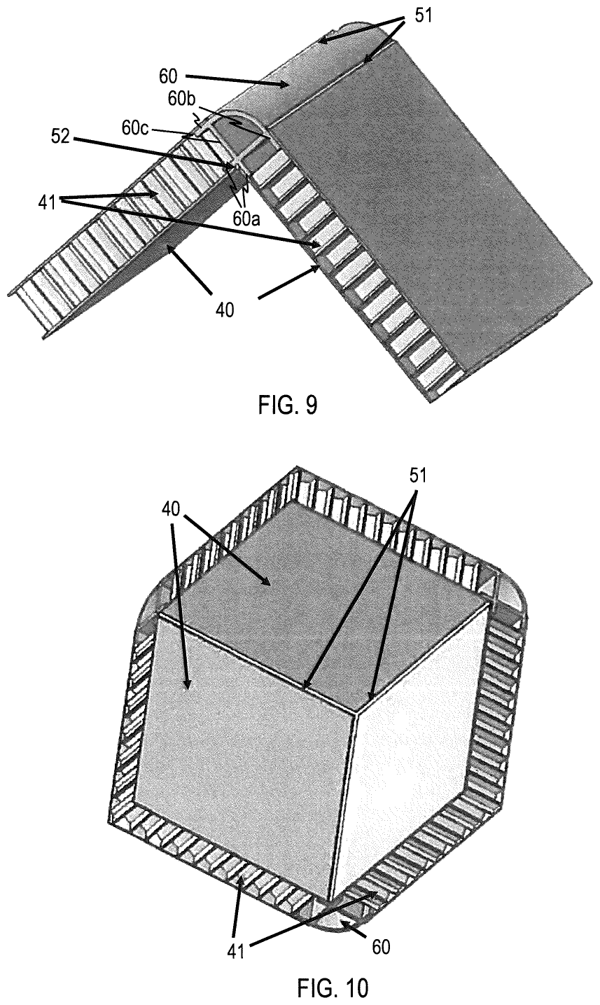

FIG. 9 shows composite panels 40 that extend angled to each other and, in particular, that are angled by 90° relative to each other. A joining element 60 may include two abutment portions 60a, 60b that that extend parallel in abutment with the inner surfaces of the skin layers of the composite panels 40 that are to be joined. Two first abutment portions 60a of the joining element 60 are angled relative to each other by 90°, and two second abutment portions 60b of the joining element 60 are angled relative to each other by 90°. The joining element 60 has at least one strut 60c, for example two struts 60c, extending between the two abutment portions 60a, 60b. An outer surface of the joining element 60 may be curved, e.g., in the shape of a cylinder surface section.

The joining element 60 may have a length that is equal to the length of the composite panels 40 along the edge along the composite panels 40 are to be joined.

Weld seams 51 are formed between the first skin layers of the adjacent composite panels 40 and the joining element 60. A weld seam 52 is formed between the second skin layers of the adjacent composite panels 40. The weld seams 51, 52 are formed at locations overlapping with the abutment portions 60a, 60b of the joining element 60, and offset (in a direction parallel to the plane in which the composite panels 40 extend) from the honeycomb cores 41.

While weld seams 51, 52 are shown, bolting or riveting may be used to attach adjacent composite panels 40. The connection may be made oil-tight by using an oil-tight joining element.

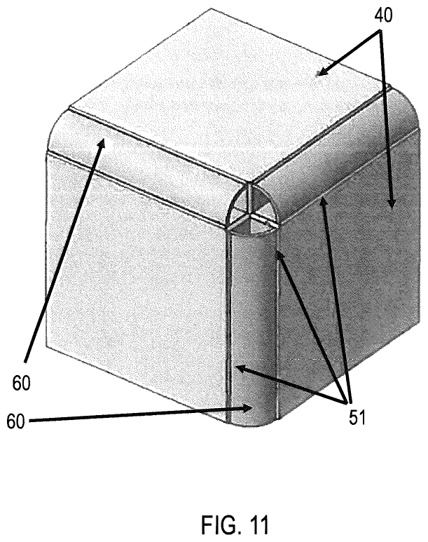

While two composite panels 40 are shown in FIG. 9, the joining techniques may be applied to more than two composite panels 40. The more than two composite panels 40 may be arranged in a three-dimensional array, as illustrated in FIGS. 10 and 11. The more than two composite panels 40 include at least a first composite panel, a second composite panel, and a third composite panel, with the first composite panel being arranged at an angle of 90° relative to each of the second and third composite panels, and the second and third composite panels being arranged at an angle of 90° relative to each other.

The three-dimensional array of composite panels includes composite panels 40 and several joining elements 60 inserted between honeycomb cores of adjacent composite panels, such that the skin layers 42, 43 of the adjacent composite panels overlap the joining elements 60. The weld seams 51, 52 may respectively be offset from the areas at which the honeycomb core 41 is adhered to the skin layers of the composite panel 40. This allows glue degradation to be reduced and mitigates the risk of causing damage to the honeycomb core 41 of the composite panel 40.

In the joining techniques described with reference to FIGS. 7 to 11, weld seams 51, 52 are offset from glued section of the composite panels 40 at which the honeycomb core 41 is adhered to the skin layers 42, 43. This is done to avoid heat dissipation into the adhesive layers or honeycomb cores 41, which could affect the quality of bonding between the honeycomb core 41 and the skin layers 42, 43 and could cause damage to the composite panels 40.

The offset is attained by elongating the skin layers 42, 43 over the honeycomb core 41 and introducing an intermediate element 50, 60 that is weldable with the skin layers 42, 43 to provide a connection, as explained with reference to FIGS. 7 to 11.

Other joining techniques may be used, such as bolting or riveting.

Larger box-like structures of composite panels may be formed. Different types of joining elements 50, 60 may be used on different parts of the box-like structure. Joining elements 50 of a first type may be used for joining co-planar adjacent composite panels, and joining elements 60 of a second type different from the first type may be used for joining adjacent composite panels that are angled relative to each other.

A closed, oil-tight, box-like structure can be formed by joining pre-manufactured composite panels 40. This type of constructions can be used as transformer tank 10. The characteristics of the multilayered composite panels 40 provide enough stiffness so that internal stiffening ribs can be omitted, which are conventionally frequently used in transformer tanks. Fluid-tightness can be attained by providing fluid-tight weld seams or by using a separate fluid-tight insert, as has been explained in more detail herein.

Various effects are associated with the joining techniques explained with reference to FIGS. 7 to 11. The joining method is capable of providing an oil-tight connection for composite panels 40 by using an additional intermediate element 50, 60 and welding. The characteristics of the composite panels 40 are not adversely affected. It is possible to construct box-like structures in various sizes, including sizes that have edge lengths that are greater than the edge lengths of a single composite panel 40. Transformer tanks are provided that are easier to manufacture using composite panels. The use of an inner tank surface that is free from reinforcing stiffeners allows the active part to be positioned more closely to the tank walls, reducing the amount of insulation fluid needed in the tank. The composite panels 40 provide a weight reduction as compared to conventional transformer tanks with comparable mechanical characteristics.

The transformer tanks according to the subject matter described herein can be used for oil-insulated transformers, without being limited thereto. Embodiments may be used for, e.g., distribution transformers.

While the subject matter has been described in detail in the drawings and foregoing description, such description is to be considered illustrative or exemplary and not restrictive. Variations to the disclosed embodiments can be understood and effected by those skilled in the art and practicing the subject matter as claimed, from a study of the drawings, the disclosure, and the appended claims. In the claims, the word “comprising” does not exclude other elements or steps, and the indefinite article “a” or “an” does not exclude a plurality. The mere fact that certain elements or steps are recited in distinct claims does not indicate that a combination of these elements or steps cannot be used to advantage, specifically, in addition to the actual claim dependency, any further meaningful claim combination shall be considered disclosed.

1. A transformer, comprising:
a tank having tank walls, wherein the tank walls comprise composite panels having a core, and wherein the tank has a fluid-tight insert, wherein the composite panels abut on an outer surface of the fluid-tight insert.

2. The transformer of claim 1, wherein the fluid-tight insert is oil-tight.

3. The transformer of claim 1, wherein a bottom and plural sides of the fluid-tight insert are integrally formed or joined to each other by welding.

4. The transformer of claim 1, wherein the fluid-tight insert (30) is made of metal.

5. The transformer of claim 1, wherein the fluid-tight insert is made of polymer.

6. The transformer of claim 1, wherein an inner surface of the fluid-tight insert is composed of planar faces.

7. The transformer of claim 6, wherein the inner surface of the fluid-tight insert is free from stiffener structures.

8. The transformer of claim 1, wherein the composite panels have a higher bending stiffness than the fluid-tight insert.

9. The transformer of claim 1, wherein the tank walls include a bottom wall and several side walls, wherein the bottom wall and each of the several side walls respectively comprises at least one of said composite panels.

10. The transformer of claim 9, wherein the bottom wall comprises several composite panels and/or each of the several side walls comprises several of said composite panels.

11. The transformer of claim 1, wherein the transformer comprises bushings and wherein the composite panels contain or are made of non-magnetic materials adjacent the bushings.

12. The transformer of claim 1, wherein the composite panels include a filler in cells of the core.

13. A method of producing a transformer tank, comprising:
forming a fluid-tight insert and
affixing composite panels having a core, on the fluid-tight insert in such a way that the composite panels abut on an outer surface of the fluid-tight insert.

14. The method of claim 13,
wherein the fluid-tight insert is an integral component having a bottom and sides, wherein the method further comprising forming the bottom and sides by bending or by vacuum forming.

15. The method of claim 13, wherein affixing the composite panels on the fluid-tight insert comprises affixing the composite panels by means of an adhesive.

16. The method of claim 13, wherein the core comprises a honeycomb core.

17. The method of claim 14, further comprising joining the bottom and sides of the fluid-tight insert by oil-tight weld seams.

18. The method of claim 13, wherein forming the fluid-tight insert comprises forming the fluid-tight insert from at least one of metal and polymer.

19. The transformer of claim 1, wherein a bottom and a plurality of sides of the fluid-tight insert are formed by bending or vacuum forming.

20. The transformer of claim 1, wherein the core comprises a honeycomb core.
